(19) United States
(12) Patent Application Publication
(10) Pub. No.: US 2018/0342805 A1
(43) Pub. Date: Nov. 29, 2018

(54) BAR-SHAPED INDUCTIVE COMPONENT

(71) Applicant: INTICA SYSTEMS AG, Passau (DE)

(72) Inventors: Thomas Sicklinger, Untergriesbach (DE); Thomas Anetseder, Thyrnau (DE)

(21) Appl. No.: 15/778,846

(22) PCT Filed: Oct. 18, 2016
(86) PCT No.: PCT/EP2016/074968

§ 371 Date: May 24, 2018

(30) Foreign Application Priority Data
Dec. 23, 2015 (DE) 202015107067.5

(51) Int. Cl. H01Q 7/08; H01F 27/26; H01Q 1/32

(52) U.S. Cl. CPC H01Q 7/08; H01F 17/04; H01Q 1/3241; H01F 27/263

(57) ABSTRACT

The bar-shaped inductive component is made up of a core made from magnetic material and a mounting element for the core, which is divided into a series of individual cores. These are arranged and fixed relative to one another by means of the mounting element so that the ends adjoining one another overlap. At the same time, it is stipulated that the individual cores are offset relative to one another in at least two layers.

### BACKGROUND OF THE INVENTION

The invention relates to a bar-shaped inductive component with a core made of magnetic material and a holding element for the core.

Such inductive components are used, for example, as bar antennas with a ferrite core for contactless information and signal exchange and, when reinforced up to a length of 100 mm, in devices such as motor vehicles with keyless go systems. The objective of the OEM is also to keep the number of antennas as small as possible on cost grounds and, at the same time, to increase the automobile's ability to communicate with the access system in terms of range. By doubling the antenna length, a 100% increase in range is also achievable, whereas doubling the surface area leads only to about a 10% increase in range.

Against this background, it is desirable to provide bar-shaped inductive components, in particular ferrite antennas with a length as great as possible, for example 300 mm. However, a problem remains in that continuous ferrite cores of such large lengths can be technically difficult to manufacture and can result in high production costs.

An attempt has therefore been made to construct ferrite bar antennas with ferrite cores of circular or square cross-sections in series. However, there remains a problem with a too large air gap between the individual cores in the series, caused by production tolerances and breaks in the core system, which greatly reduces the range of the bar antenna, for example, during communication with the vehicle key.

From U.S. Patent Application Publication No. 2002/0122011, a bar antenna is known which consists of individual cores arranged flush against one another in series, connected on one side by an elastic band.

German Patent No. DE 10 2013 222 435 A1 describes and illustrates an inductive element composed of at least two bar-shaped magnetic core elements, whose ends are flush against one another. Also, one end is formed as a sphere and engages in a cylindrical recess at the end of the attached magnetic core element.

### SUMMARY OF THE INVENTION

It is an object of the invention is to form an inductive component of above delineated type such that the stability of the bar-shaped component remains guaranteed despite a noticeable increase in length.

The solution to this problem is obtained by a core divided into a series of individual cores, which are fixed relatively to each other by means of the mounting element such that the adjacent ends overlap and are offset relatively to each other in at least two positions. Overlapping the individual cores, according to the building block principle makes possible, for example, to manufacture antennas with a length of over 100 mm and more. As the individual cores are nested not only in length, but also in height, the stability does not suffer as a result. The geometry of the mounting element—in the case of a bar antenna preferably formed as an injection moulded coil body—is adapted accordingly.

Preferably, the overlapping of the individual cores corresponds to at least half the area of the front of the individual cores, so that not only stability is achieved in a longitudinal direction, but also the necessary magnetic connection in the area of the overlap. A possible air gap between two consecutive individual cores is compensated by the resulting area of overlap.

In the area of the overlap, the individual cores can adjoin each other with a friction fit, whereby they are, for example, fixed by the wire winding tension of the coil or they can be glued with one another. The gluing option improves the connection between the individual cores, but the manufacturing costs are also increased. The advantage of non-glued connection points is greater flexibility of the entire component and more cost-effective production.

### BRIEF DESCRIPTION OF THE DRAWINGS

The invention is explained below in an example embodiment that is illustrated in the drawings. These show:

FIG. 1 is a schematic view of an inductive component according to the invention;

FIG. 2 is a view of an individual core;

FIG. 3 is a top view of a variant to the top part used in FIG. 1, of the mounting element, formed as a coil body;

FIG. 4 is a view of the bottom part of the mounting element in FIG. 3;

FIG. 5 is a view of a ferrite antenna encased in a housing according to the invention; and

FIG. 6 is a bottom view of the ferrite antenna in FIG. 5.

### DETAILED DESCRIPTION OF THE INVENTION

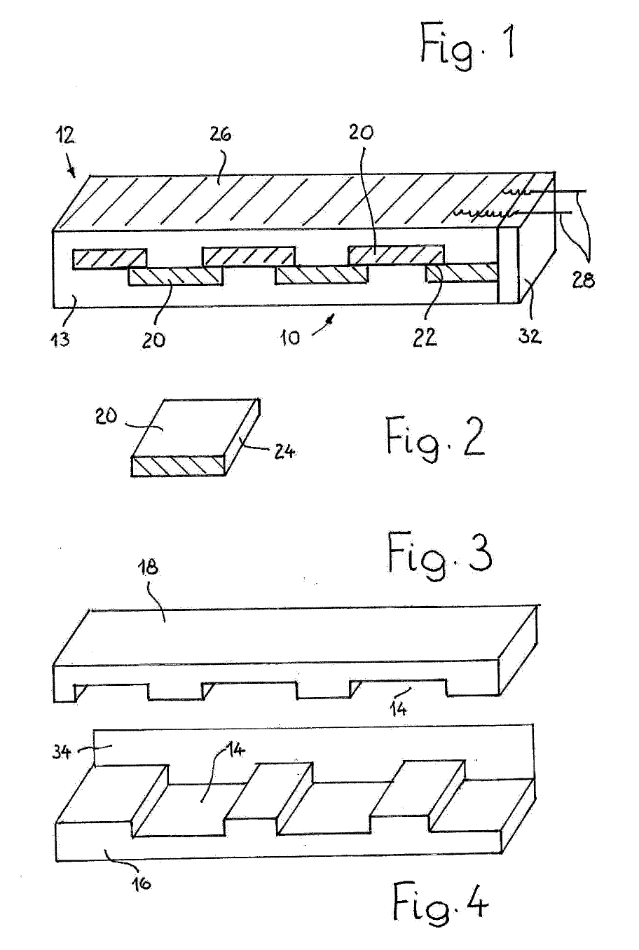

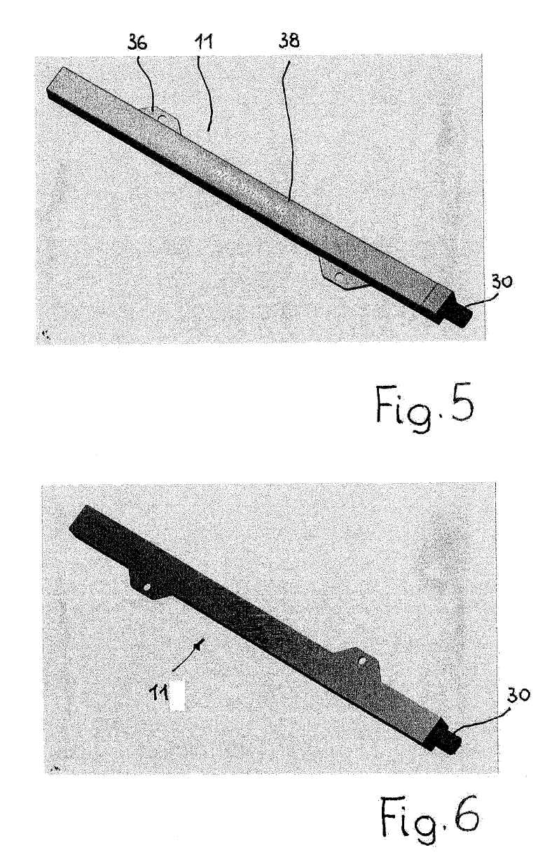

In FIGS. 1 and 2, as well as in FIGS. 3 and 4, schematic views of two alternatives for the possible construction of a bar-shaped inductive component 10 according to the invention are illustrated which, as shown in FIGS. 5 and 6, can be used as LF [low frequency] ferrite antennas 11 for frequency ranges from approx. 120 to 130 kHz or 14 to 25 kHz.

The inductive component 10 comprises a core made of magnetic material, in general ferrite, and a mounting element 12 for the core, which is formed as a coil body 13 and can be manufactured as a one-piece injection-moulded component, e.g. from polyamide (PA).

In the mounting element 12, cuboid recesses 14 are incorporated, which are closed on the not-shown rear side and extend over the width of the coil body 13, the length of which can be 100 mm or more. In the example shown in FIGS. 3 and 4, the coil body 13 is divided in a central plane and thus forms a bottom part 16 and a top part 18, both of which are firmly interconnected and have a rear wall 34, so that each recess 14 is open in the side opposite the rear side, whereby push-in openings for the cuboid individual cores 20 are formed.

An individual core 20, consisting here of ferrite, is inserted into each recess 14, whereby the arrangement of the recesses 14 in the longitudinal direction of the coil body 13 makes a building-block-like connection between the individual cores 20, in which the ends 22 of the individual cores 20 adjoining each other overlap. The cuboid individual cores 20 which can have other forms, for example trapezoidal or rhomboid cross-sections, are overlapped over an area which equals at least half the area of the front 24 of each individual core 20. The recesses 14, into which the individual cores 20 are inserted, also serve simultaneously as spacers between the individual cores 20.

FIG. 1 shows that the coil body 13 is closed at one end by means of a cover 32, which can be injection moulded as a single part with the coil body 13. In the example given in FIG. 1, the complete ferrite core consists of six individual cores 20 with a length of approximately 80 mm, a width of 13 mm and a height of 3 mm. The individual cores 20 can also be offset relative to one another in more than two layers.

FIG. 1 shows that the complete coil body 13 for manufacturing the inductive component 10 is wound in a known manner, for example, with around 50 turns of a strip-shaped flat copper wire 26. Both ends of the winding wire 26 are connected in a known manner in each case with a pin 28, by which the plug outline 30 indicated in FIGS. 5 and 6 is formed.

It is clear from FIGS. 5 and 6 that the coil body 13 of the ferrite antenna 11 is enclosed within a housing 38, with two bolt-on links 36, which allow for both horizontal (see FIG. 1) and vertical alignment. In a vertical construction, the flexibility of the structure is improved compared with a horizontal installation, as core gaps are prevented. With vertical pressure loading from above, contact between the frictionally adjacent ends 22 is maintained; with a horizontal construction, these could be opened under pressure from possible bending stresses.

1. A Bar-shaped inductive component with a core made from magnetic material and a mounting element for the core, the core is divided into a series of individual cores, the series of individual cores are arranged and fixed relative to one another by means of the mounting element, so that ends of the series of individual cores adjoining one another overlap, and wherein the series of the individual cores are offset relative to one another in at least two layers.

2. The Bar-shaped inductive component according to claim 1, wherein the series of the individual cores comprise a cuboid shape or are formed trapezoidal or rhomboid in their cross-section, wherein the overlapping of the series of the individual cores equals at least half an area of a front of the series of the individual cores.

3. The Bar-shaped inductive component according to claim 1, wherein the series of the individual cores are fixed to one another in the area of overlapping.

4. The Bar-shaped inductive component according to claim 1, wherein the mounting element comprises a coil body made as an injection-moulded part, having recesses corresponding to a shape of the series of the individual cores, into which the series of the individual cores are inserted.

5. The Bar-shaped inductive component according to claim 4, wherein the recesses comprise push-in openings for the series of the individual cores, and whereas they recesses are closed on a rear side opposite the push-in openings.

6. The Bar-shaped inductive component according to claim 4, wherein the injection-moulded part of the coil body comprises a bottom part and a top part connected to the injection-moulded part, and the bottom part and the top part are connected to one another.

7. The Bar-shaped inductive component according to claim 4, wherein the coil body is wound.

8. The Bar-shaped inductive component according to claim 4, wherein a length of the coil body is at least 100 mm.
